(19) United States
(12) Patent Application Publication
(10) Pub. No.: US 2005/0198898 A1
(43) Pub. Date: Sep. 15, 2005

(54) Plant basket divider

(76) Inventor: Paul Andrew Vogt, W. St. Paul, MN (US)

Correspondence Address: PAUL ANDREW VOGT, 1058 OTTAWA AVE., W. ST. PAUL, MN, 55118, US

(21) Appl. No.: 10/797,277

(22) Filed: Mar. 11, 2004

(51) Int. Cl. A01G 9/02

(52) U.S. Cl. 47/65.6

(57) ABSTRACT

An insert divider that allows a plant basket to become self watering as a solid plate portion with a wick system would separate the inner area of a plant basket, forming a lower water reservoir region and an upper plant soil region. A raised section on the solid plate portion aids in refilling water reservoir when aligned with accommodating hole in plant basket side wall.

### BACKGROUND OF THE INVENTION

The present invention relates to potted plants and, in particular, to a discrete solid plate insert divider which would enhance a plant basket or hanging plant basket with the benefit of having a large water reservoir that would supply water as needed to a plant for a prolonged period of time.

The majority of potted plants need constant tending, especially water, seeing as there is limited soil. Either due to plant consumption or evaporation most potted plants need to be watered every other day which can make them more of a hassle than a pleasure.

All plant baskets incorporate some type of water drain hole in their bottom to prevent over saturation of soil, which can suffocate a plant's roots and in general terminate the life of a plant. The main drawback of this various design is that the majority of water applied runs out the plant basket bottom.

Other plant baskets have raised drain holes and incorporate a strainer creating a pocket in their basin which provides a limited pool of water in the basket bottom, but these various designs have a major shortcoming in that a plant's roots will pass through the strainer and be susceptible to airborne funguses which will sicken and in turn terminate the life of a plant.

Applicant is also aware of a variety of plant baskets that incorporate the use of a secondary water basin that in some cases may be attached to a plant basket. This system in most cases promotes over watering, leading to a lack of oxygen in the soil, thus causing less than ideal conditions for growing a healthy plant.

With the exception of the foregoing plant basket various strainers and secondary basin type water systems that are available, applicant is unaware of a solid plate plant basket divider having water wick system and protective water inlet shroud.

Applicant accordingly believes a need exists for a plant basket divider that allows plants to become self sustaining for longer periods of time, and healthier due to having well balanced moisture/oxygen soil content.

Applicant also wishes to disclose the fact that he unveiled for the first time a plant basket divider with water wick system and protective water inlet shroud, incorporated into an accommodating plant basket at the National Hardware Show in Chicago, Ill. Aug. 10, 11, 12, 2003 but has not made any market sales as of March, 2004.

### SUMMARY OF THE INVENTION

In appreciation of the need for the forgoing plant basket divider and the shortcomings of available plant basket strainers and secondary basins, applicant has developed a plant basket insert divider which creates a large water reservoir within a plant basket (pot) that would promote healthier and more robust plants that need less tending.

It is accordingly a primary objective of the invention to provide a means to wick or draw water from the created water reservoir to the plant soil area.

It is further object of the invention to provide a divider having a raised shroud portion that would work in unison with an accommodating plant basket for refilling created water reservoir.

It is further object to provide a divider that accommodates a variety of plant baskets (pots).

It is still further object of the invention to provide for a divider which may be constructed as a single piece part, except for the wick system, to minimize cost.

The above objects, advantages and distinctions of the invention are achieved in a construction developed by applicant.

The embodiment, a molded plastic plant basket divider is molded to provide a flat solid plate, wherein are one or more holes that capture a wick material, and wherefrom a snout shaped shroud projects upwardly to aid in refilling of created water reservoir.

The foregoing objects, advantages and distinctions of the invention, as well as its detailed construction, will become more apparent hereinafter upon reference to the following descriptions thereof with respect to the appended drawing. Before referring thereto, it is to be appreciated the following description is made by way of the presently preferred embodiment, which should not be interpreted in limitation of the spirit and scope of the invention as claimed hereinafter.

### BRIEF DESCRIPTION OF THE DRAWINGS

FIG. 1 shows an isometric view of a plant basket divider.

FIG. 2 shows a plant basket divider within accommodating plant basket.

### DESCRIPTION OF THE PREFERRED EMBODIMENT

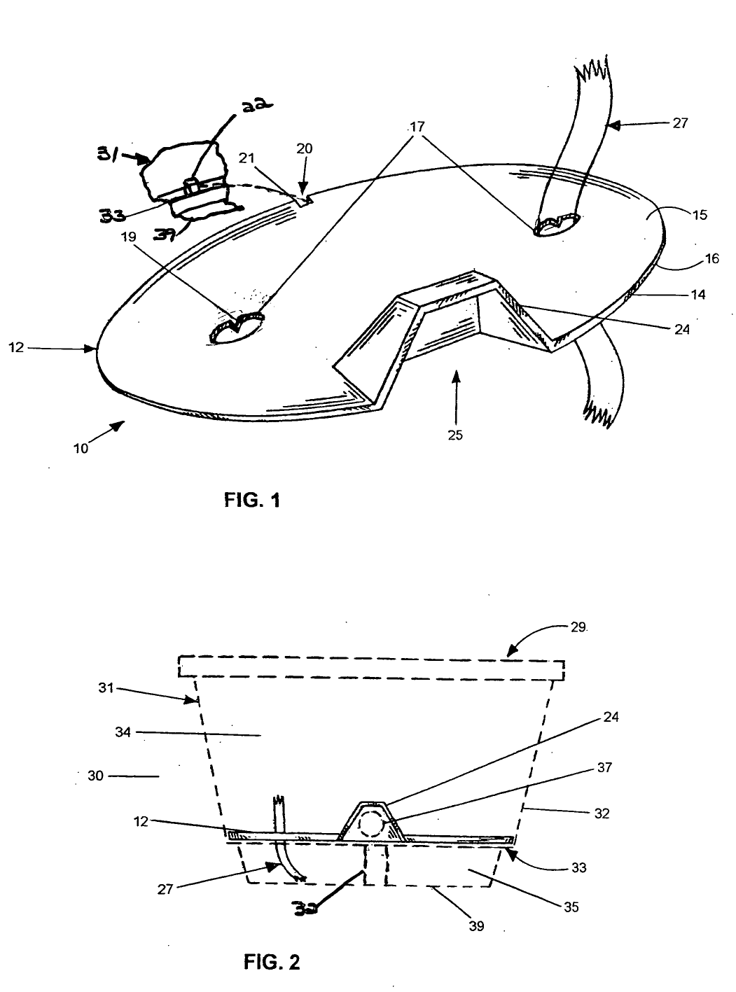

Referring to FIG. 1, an isometric view is shown of a presently preferred, plant basket divider 10. Generally the divider 10 is formed as a single piece embodiment shaped to be compatible with an intended round plant basket 31 as shown in FIG. 2.

The majority of the divider 10 is comprised of a round solid plate portion 12 wherein its center area are open holes 17 having a barbed projection 19 which work in unison to allow a section of rope 27 or other suitable absorbent material to be drawn through the plate 12 yet be captured by the barbed 1 projection 19 at an appropriate point in the overall length of the piece of rope 27.

On the outer edge 14 of the plate portion 12 is an alignment key slot 21 having an open recess 20 which would act to properly align the water shroud 24 that projects upwardly from the flat upper surface 15 and inwardly from the edge 14, creating an open recess 2 towards the lower surface 16 of the plate portion 12 on the divider 10.

With further attention directed to FIG. 2, an assembly incorporates the divider 10 into an accommodating plant basket 31.

The plant basket 31 having an inner ledge 33 or step encompassing its sidewall 32 would support the divider 10, whereupon the interior area 29 of said basket 31 is separated to form an upper soil section 34 and a lower water reservoir 35.

The water reservoir 35 would be refillable via a portal hole 37 which also acts as a water overflow hole and lies just above the ledge 33 and through the side wall 32 of the plant basket 31. The shroud 24 on the divider 10 acts to shield the portal hole 37 from the upper soil section 34, while providing an open recess 25 for water to be administered into the created water reservoir 3. The shroud 24 is aligned appropriately with the portal hole 37 by the key slot 21 on the plate portion 12 of the divider 10 being engaged with a small protrusion (not shown) on the inner ledge 33 of the plant basket 31.

The divider 10, thus having created an enclosed water reservoir 35, which would hold several cups of water within the interior 29 of plant basket 31 would dispense water appropriately upward into the soil section 34 via absorbent rope 27, or suitable material inserted through the solid plate portion 12.

The solid nature of the divider 10 and its application into an accommodating plant basket 31 will exclude soil and plant roots from entering the created water reservoir 35 thus preventing unhealthy conditions for growing a plant, as well as impede water evaporation from said reservoir 35, prolonging time between plant tending.

The embodiment itself is particularly molded from a polypropylene or other suitable plastic material. Such materials also find ready application with the injection molding process and have exceptional strength and durability properties.

In passing, it might also be noted that the divider 10 is approximately 7 to 9 inches wide and approximately ⅛ to ¼ inches thick. The shroud 24 is approximately 2 to 3 inches tall, approximately 2 to 3 inches wide and approximately 1 to 2 inches deep. The recess 25 is approximately 1 to 2 inches deep. The hole(s) 17 are approximately ¼ to ½ inches in diameter. The foregoing dimensions are however illustrative only of a presently preferred embodiment and may be appropriately changed as necessary to accommodate a variety of different types and sizes of plant baskets 31.

It should also be noted that the preferred embodiment, if incorporated into a plant basket 31 that is overly large, may require at least one support pillar (not shown) that would project downwardly from the center area of the solid plate portion 12 lower surface 16 allowing contact with the inner base 39 of said basket 31 to aid the divider 10 in holding the overall weight of the soil section 34.

Whereas, too, the exterior edge 14 of the plate portion 12 is generally round, it may be squared as desired.

While the present invention has been described with respect to its preferred embodiment, it is to be appreciated that still other embodiments and modifications thereto might be suggested to those of skill in the art. Accordingly, it is contemplated that the following claims should be interpreted to include all those equivalent embodiments within the spirit and scope of the invention.

1-12. (canceled)

13. A plant basket comprising:
a) an open-topped pot having an outward directed, flanged wall displaced along a sidewall and above a bottom wall and including an alignment key that projects from an interior surface of said sidewall, and further including an aperture that extends through said sidewall above said flanged wall; and
b) a plate member supported on said flanged wall having a generally flat portion and a water inlet shroud that rises from said flat portion and communicates with a peripheral edge of said plate member, wherein said shroud comprises a successively increasing portion of said plate member that rises above said aperture such that a bottom surface portion of said plate member surrounds said through aperture and defines a channel that communicates with an open space within said pot beneath said plate member, wherein said plate member includes a recess at said peripheral edge that mates with said key and aligns said shroud to said aperture, wherein said plate member includes a hole having a barbed edge that projects into a bore of said hole, and wherein an absorbent wick member is mounted in said bore and secured to said barbed edge to extend generally orthogonal to said plate member, whereby water stored in the bottom of said pot is wicked into soil contained in said pot above said plate member.

14. A plant basket as set forth in claim 13 wherein said wick member comprises a length of rope.

15. A plant basket as set forth in claim 13 wherein said plate member includes a depending support pillar that contacts said bottom wall.

16. A plant basket as set forth in claim 13 wherein said key projects from said flanged wall.

17. A plant basket comprising:
a) an open-topped pot having a support surface displaced along a sidewall and above a bottom wall and including an alignment key that projects from an interior surface of said sidewall, and further including an aperture that extends through said sidewall above said flanged wall; and
b) a plate member supported on said support surface to define a water reservoir between said bottom wall and said plate member and having a generally flat portion and a water inlet shroud that rises from said flat portion and communicates with a peripheral edge of said plate member, wherein said shroud comprises a successively increasing portion of said plate member that rises above said aperture such that a bottom surface portion of said plate member surrounds said through aperture and defines a channel that communicates with said water reservoir, wherein said plate member includes a recess at said peripheral edge that mates with said key and aligns said shroud to said aperture, wherein said plate member includes a hole having a barbed edge that projects into a bore of said hole, and wherein an absorbent wick member is mounted in said bore and secured to said barbed edge to extend generally orthogonal to said plate member, whereby water stored in said water reservoir is wicked into Soil contained in said pot above said plate member.

18. A plant basket comprising:
a) an open-topped pot having an outward directed, flanged wall displaced along a sidewall and above a bottom wall and including an alignment key that projects from an interior surface of said sidewall, and further including an aperture that extends through said sidewall above said flanged wall; and
b) a plate member supported on said flanged wall having a generally flat portion and a water inlet shroud that rises from said flat portion and communicates with a peripheral edge of said plate member, wherein said shroud comprises a successively increasing portion of said plate member that rises above said aperture such that a bottom surface portion of said plate member surrounds said through aperture and defines a channel that communicates with an open space within said pot beneath said plate member, wherein said plate member includes a recess at said peripheral edge that mates with said key and aligns said shroud to said aperture, wherein said plate member includes a hole having a bore, and wherein an absorbent wick member is mounted in said bore and secured to said hole to extend generally orthogonal to said plate member, whereby water stored in the bottom of said pot is wicked into soil contained in said pot above said plate member.
